(19) United States
(12) Patent Application Publication
(10) Pub. No.: US 2004/0200157 A1
(43) Pub. Date: Oct. 14, 2004

(54) Method of reinforcing a metal container and reinforced metal container

(75) Inventors: Baruch Gedalia, Paris (FR); Sebastien Diaz, Chalon-Sur-Saone (FR); Herve Ridoux, Marseille (FR)

Correspondence Address: BANNER & WITCOFF, LTD., TEN SOUTH WACKER DRIVE, SUITE 3000, CHICAGO, IL, 60606, US

(73) Assignee: FREYSSINET INTERNATIONAL (STUP), Velizy Cedex (FR)

(21) Appl. No.: 10/781,602

(22) Filed: Feb. 18, 2004

(30) Foreign Application Priority Data
Mar. 3, 2003 (FR) FR 03 02548

(51) Int. Cl. F17C 1/06; E04H 9/02; E04B 1/98

(52) U.S. Cl. 52/167.1; 52/167.3; 156/71

(57) ABSTRACT

Reinforcement of a metal container against seismic or paraseismic stresses, in which the metal container is surrounded over at least part of its height with carbon fibre fabric bonded to the external surface of the metal container, and in which the carbon fibre fabric is placed in bands extending substantially over the entire circumference of the metal container, predominantly in a direction substantially perpendicular to an axis of the metal container.

### CROSS REFERENCE TO RELATED APPLICATIONS

This application claims priority to France Patent Application Ser. No. FR 03 02548, filed Mar. 3, 2003, which is incorporated herein by reference in its entirety.

### BACKGROUND OF THE INVENTION

The present invention relates to the reinforcement of metal tanks or containers against seismic or paraseismic stresses.

It is more particularly aimed at containers made of sheet steel having a relatively small thickness in order to limit the manufacturing cost. They are therefore subject to large deformations in the event of unusual stresses.

This is especially the case when a seismic event occurs. The container, generally filled with fluid, is then stressed by internal overpressurization of the fluid owing to the horizontal acceleration and to the variations in the free surface of the fluid. Furthermore, a general overturning moment may induce a high compressive force on one part of the container and, conversely, a high tensile force on the opposite part of the container.

The deformation of the sheet metal resulting from combination of these stresses then results in the second-order effects and possibly in buckling or doming, that is to say localized bending of the sheet metal. Such buckling, which generally appears at the bottom of the container, is sometimes referred to as an “elephant foot” distortion, owing to its shape. This phenomenon is illustrated in FIG. 1, in which the buckling, appearing at the bottom of the container 1, bears the reference 2.

There are known solutions for limiting the above mentioned effects that involve the reinforcement of metal containers. In particular, the technique of hoop reinforcement consists in placing, around a container, a confining hoop for preventing the radial expansion resulting from the internal pressure or the buckling. The “active” hoop reinforcement is thus made up of prestressed hoops around the container. These hoops exert a permanent force on the structure. However, this technique poses size difficulties, since the force exerted must be acceptable in the case of an empty container. In actual fact, the compressive strength of the sheet metal of such a container when empty is very low.

Another solution, called stiffening, consists in the addition of material (stiffeners) in order to locally reinforce certain sections of the container and therefore to limit the deformation thereof. In practice, this technique requires the stiffeners to be welded to the container, this having the effect of weakening the structure that it is desired to reinforce. Furthermore, if the stiffening operation is carried out while the container is filled with a flammable substance, there may be a risk of fire or deflagration.

It is an object of the present invention to propose a method of reinforcing metal containers that limits the abovementioned drawbacks.

In particular, it is an object of the invention to allow reinforcement of a container that may be carried out when it is empty or when the container is full and in operation.

It is another object of the invention to allow reinforcement that does not weaken the sheet metal.

### SUMMARY OF THE INVENTION

The invention thus proposes a method of reinforcing a metal container against seismic or paraseismic stresses, in which the metal container is surrounded over at least part of its height with carbon fibre fabric bonded to the external surface of the metal container and in which the carbon fibre fabric is placed entire in bands extending circumference of substantially the metal around the container, predominantly in a direction substantially perpendicular to an axis of the metal container.

In embodiments that may be combined with one another in any manner:

the carbon fibre fabric is bonded to the external surface of the metal container in such a way that the carbon fibres lie predominantly along a direction substantially perpendicular to an axis of the metal container;

the metal container is at least partly filled and the metal container is surrounded with a carbon fibre fabric without the metal container being emptied;

the carbon fibre fabric is bonded to the external surface of the metal container so as to bypass around projecting regions on the said part of the external surface of the metal container;

the carbon fibre fabric is bonded to the external surface of the metal container in several superposed layers;

the number of superposed layers of the carbon fibre fabric varies with the height along the metal container; and

the carbon fibre fabric is placed in bands and the superposed layers are offset with respect to one another by half the width of a band.

The invention also provides a metal container reinforced against seismic or paraseismic stresses by means of the said method.

Such reinforcement reduces the effects of seismic or paraseismic stresses, especially the appearance of bucking of the reinforced container.

### BRIEF DESCRIPTION OF THE DRAWING

In the detailed description which follows reference will be made to the drawing comprised of the following Figures:

FIG. 1, already commented upon, is a diagram illustrating a deformation of a conventional metal container as a result of a seismic stress; and;

FIG. 2 shows diagrammatically a metal container reinforced against seismic stresses according to one embodiment of the invention.

### DESCRIPTION OF THE PREFERRED EMBODIMENTS

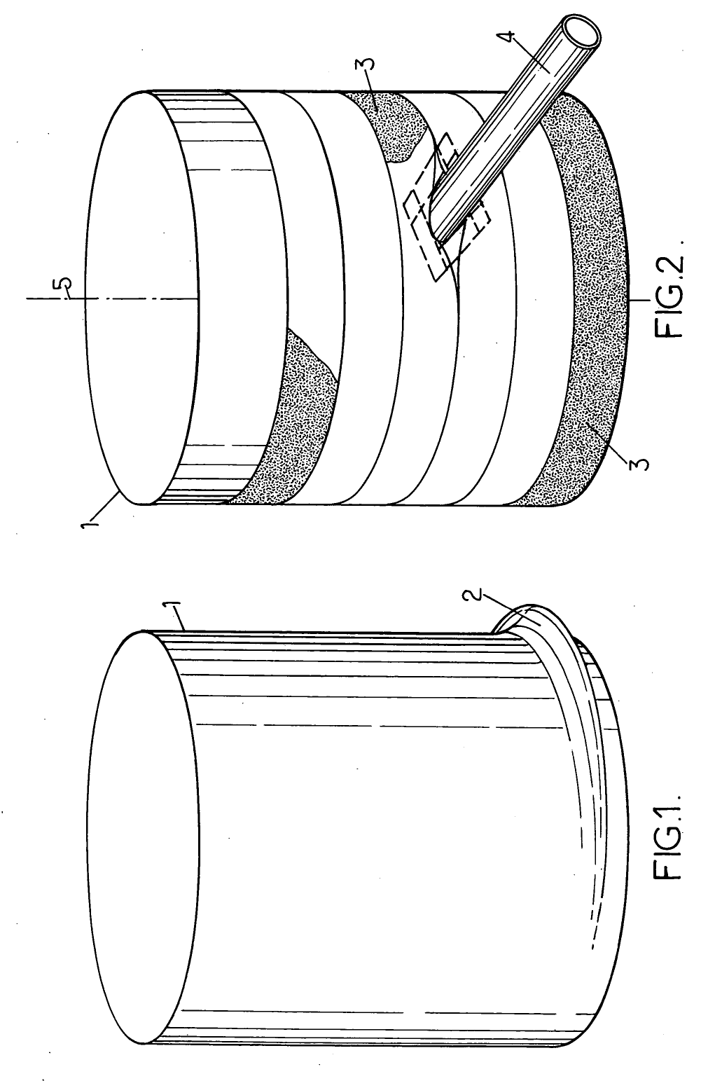

FIGS. 1 and 2 show a metal container, such as those used in industry, typically made of thin sheet steel. By way of illustration, such a cylindrical container may have a height of some fifteen metres with a diameter of around ten metres. The thickness of the sheet metal of the container 1 than around 10 millimetres is conventionally less than around 10 millimetres.

A reinforcement is applied to the container 1 according to the invention so as to limit the buckling 2 phenomenon, described above, when seismic or paraseismic stresses occur.

This reinforcement consists in bonding the carbon fibre fabric 3 to at least part of the external surface of the container 1. It may be carried out when the container is empty, but also when the container is filled, for example with a fluid.

Such a carbon fibre fabric is a strong material (tensile strength typically greater than 1500 MPa) with a high elastic modulus (typically between 200 and 400 GPa).

In one embodiment of the invention, the carbon fibre fabric is cut into bands. These are then applied to the external surface of the container 1. It may then be advantageous to place these bands on the container so as to follow a principal direction. For example, the carbon fibre fabric bands may be positioned perpendicular to the vertical axis 5 of the container, as shown in FIG. 2.

Moreover, the fibres themselves may have a principal direction within the fabric. For example, most of the fibres may have a first direction and the remainder of the fibres a direction perpendicular to the first. In this case, it may be advantageous to place the carbon fibre fabric on the container 1 in such a way that most of the fibres are oriented horizontally, that is to say perpendicular to the vertical axis 5 of the cylindrical container. This IS because the buckling 2 resulting from deformation of the sheet metal during a seismic event has a tendency to extend around the circumference of the container. By positioning the fibres of the carbon fibre fabric in an essentially horizontal direction, it is therefore possible to provide a high resistance to buckling.

The carbon fibre fabric is bonded to the external surface of the container by means of suitable resins. The carbon fibre fabric adheres easily to steel using the above method of securing. Furthermore, the adhesive-bonding solution differs from other techniques by the fact that it does not require welding to the thin membrane of the container and thus avoids any weakening or puncturing of the sheet metal. The absence of welding also has the advantage of avoiding the risk of fire or deflagration when reinforcement of the container is carried out while the latter is filled with a flammable substance.

The carbon fibre fabric is positioned all around external circumference of the container so as to the encircle the latter. This jacketing therefore constitutes a passive hoop reinforcement around the container, this having no effect on the container in the empty state since no pressure is exerted on the sheet metal in this case. When the carbon fibre fabric is bonded to the sheet metal, the perfect adhesion of this jacketing also acts as a stiffener around the container. FIG. 2 shows such hoop reinforcement at certain heights of the container, using fabric bands 3 applied practically uniformly over the external surface of the container.

To obtain effective reinforcement of the container against seismic stresses, it may be advantageous to cover the surface of the container with several superposed layers of carbon fibre fabric. If the carbon fibre fabric is placed on the container in parallel bands, several bands of carbon fibre fabric may then be superposed, one on top of another.

In one embodiment, the bands of carbon fibre fabric thus superposed in layers may be offset with respect to one another. This offset between bands of adjacent layers is advantageously equal to half the width of a band. In this way, the entire external surface of the container is uniformly reinforced, including in the connecting regions between bands within one layer, which could be more sensitive to the deformation phenomenon without this overlap.

The sheet metal forming the container may have a thickness that varies over the height of the container. For example, the thickness of the sheet metal used may decrease in step with the height of the container. In such a configuration in particular, it may be advantageous to place a number of layers of carbon fibre fabric that matches the thickness of this sheet metal. Thus, it may be necessary to place several bands of carbon fibre fabric in superposed layers at the bottom of the container, whereas a single layer of carbon fibre fabric may be placed on a higher portion of the surface of the container.

In one embodiment of the invention, the container 2 includes projecting obstacles on its surface, which prevent the carbon fibre fabric from being distributed in uniform bands over its entire external surface. For example, a fluid intake pipe 4 may run through the surface of the tank. In this case, care is taken to place the carbon fibre fabric so as to bypass the obstacles, while placing, for example, tapes around the region to be bypassed, as illustrated in FIG. 2, around the fluid intake pipe 4. Positioning the carbon fibre fabric in such a way allows almost the entire surface of the container to be reinforced, despite the irregularities that it may have.

The container thus reinforced, by positioning carbon fibre fabric on its external surface, more easily withstands seismic-type stresses by modifying the behaviour of the sheet metal of which it is made. This is because, since the carbon fibre fabric is elastic and can undergo high elongations before breaking, it therefore greatly increases the stiffness of the structure even when the steel is liable to deform (plastically). Thus, the occurrence of buckling of the surface of the container is limited.

It may also be noted that the carbon fibre fabric applied is very durable. Furthermore, if the metal on which it is positioned is subject to corrosion, the carbon fibre fabric then provides the container with a protective coating.

What is claimed is:

1. Method of reinforcing a metal container against seismic or paraseismic stresses, in which the metal container is surrounded over at least part of its height with carbon fibre fabric bonded to the external surface of the metal container and in which the carbon fibre fabric is placed in bands extending substantially around the entire circumference of the metal container, predominantly in a direction substantially perpendicular to an axis of the metal container.

2. Method according to claim 1, in which the carbon fibre fabric is bonded to the external surface of the metal container in such a way that the carbon fibres lie predominantly along a direction substantially perpendicular to an axis of the metal container.

3. Method according to claim 1, in which the metal container is at least partly filled and in which the metal container is surrounded with a carbon fibre fabric without the metal container being emptied.

4. Method according to claim 1, in which the carbon fibre fabric is bonded to the external surface of the metal container so as to bypass projecting regions on the said part of the external surface of the metal container.

5. Method according to claim 1, in which the carbon fibre fabric is bonded to the external surface of the metal container in several superposed layers.

6. Method according to claim 5, in which the number of superposed layers of the carbon fibre fabric varies with the height along the metal container.

7. Method according to claim 5, in which the carbon fibre fabric is placed in bands and in which the superposed layers are offset with another by half the width of a band.

8. Metal container reinforced against seismic or in which the metal container is paraseismic stresses, surrounded over at least part of its height with carbon fibre fabric bonded to the external surface of the metal container, the carbon fibre fabric being placed in bands extending substantially around the entire circumference of the metal container, predominantly in a direction substantially perpendicular to an axis of the metal container.

9. Metal container according to claim 8, in which the carbon fibre fabric is bonded to the external surface of the metal container in such a way that the carbon fibres lie predominantly along a direction substantially perpendicular to an axis of the metal container.

10. Metal container according to claim 8, at least partly filled, the metal container being surrounded with a carbon fibre fabric without being emptied.

11. Metal container according to claim 8, in which the carbon fibre fabric is bonded to the external surface of the metal container so as to bypass projecting regions on the said part of the external surface of the metal container.

12. Metal container according to claim 8, in which the carbon fibre fabric is bonded to the external surface of the metal container in several superposed layers.

13. Metal container according to claim 12, in which the number of superposed layers of the carbon fibre fabric varies with the height along the metal container.

14. Metal container according to claim 12, in which the carbon fibre fabric is placed in bands and in which the superposed layers are offset with respect to one another by half the width of a band.
